(19) United States
(12) Patent Application Publication
(10) Pub. No.: US 2009/0127231 A1
(43) Pub. Date: May 21, 2009

(54) Methods of Forming Superhard Cutters and Superhard Cutters Formed Thereby

(76) Inventors: Chien-Min Sung, Tansui (TW); Jui-Hsuan Chiang, Sanchong City (TW); Unn-Shiuan Liao, Taipei (TW)

Correspondence Address: THORPE NORTH & WESTERN, LLP., P.O. Box 1219, SANDY, UT, 84091-1219, US

(21) Appl. No.: 12/267,124

(22) Filed: Nov. 7, 2008

Related U.S. Application Data
(60) Provisional application No. 60/986,538, filed on Nov. 8, 2007.

(51) Int. Cl. B23H 1/04

(52) U.S. Cl. 219/69.16; 219/69.11; 219/69.17

(57) ABSTRACT

A method of forming one or more features on a working surface of a superhard carbonaceous material comprises: positioning an electrode plate adjacent the superhard carbonaceous material, the electrode plate having an electrode surface oriented toward the working surface of the superhard carbonaceous material, the electrode surface including at least one protrusion or indentation formed therein or thereon; moving the electrode plate and the working surface toward one another while removing material from the working surface via electro-discharge machining; and moving the electrode plate and the working surface laterally relative to one another while removing material from the working surface via electro-discharge machining.

### PRIORITY CLAIM

This application claims the benefit of U.S. Provisional Patent Application Ser. No. 60/986,538, filed Nov. 8, 2007, which is hereby incorporated herein by reference.

### FIELD OF THE INVENTION

The present invention relates generally to methods used to form superhard cutting devices used to condition, polish, plane, or otherwise remove material from workpieces formed of various materials. Accordingly, the present invention involves the fields of chemistry, physics, and materials science.

### BACKGROUND OF THE INVENTION

Superhard carbonaceous materials are used in wide range of polishing, planing, dressing, or conditioning processes. As one example, the semiconductor industry currently spends in excess of one billion U.S. Dollars each year manufacturing silicon wafers that must exhibit very flat and smooth surfaces. Known techniques to manufacture smooth and even-surfaced silicon wafers are plentiful. The most common of these involves the process known as Chemical Mechanical Polishing (CMP) which includes the use of a polishing pad in combination with an abrasive slurry. Dressing of these CMP pads can be done with superhard PCD compacts.

Due to their very hard nature, forming and/or machining superhard carbonaceous materials can be a difficult and expensive process.

### BRIEF DESCRIPTION OF THE DRAWINGS

FIG. 1A is a side, sectioned view of portions of a superhard carbonaceous material and an electrode plate in accordance with an embodiment of the invention;

FIG. 1B is a side, sectioned view of the portions of the superhard carbonaceous material and the electrode plate of FIG. 1A, shown after the electrode plate has removed material from the carbonaceous material and moved partially into the carbonaceous material;

FIG. 1C is a side, sectioned view of the portions of the superhard carbonaceous material and the electrode plate of FIG. 1B, shown after the plate and the material have moved laterally relative to one another while material has been removed from the carbonaceous material;

FIG. 1D is a side, sectioned view of the portions of the superhard carbonaceous material and the electrode plate of FIG. 1C, shown after the plate and the material have moved laterally relative to one another in an opposing direction;

FIG. 2A is a top view of an exemplary electrode plate in accordance with an embodiment of the invention;

FIG. 2B is a side view of the electrode plate of FIG. 2A;

FIG. 3A is a sectioned view of a portion of another electrode plate in accordance with an embodiment of the invention;

FIG. 3B is a sectioned view of a portion of another electrode plate in accordance with an embodiment of the invention

FIG. 4 is a schematic representation of various portions of an electro-discharge machining system in accordance with an embodiment of the invention;

FIG. 5 is an image of a cutting device formed in accordance with the present invention; and

FIG. 6 is an image of the cutting device of FIG. 5, shown at a differing degree of magnification.

It will be understood that the above figures are merely for illustrative purposes in furthering an understanding of the invention. Further, the figures may not be drawn to scale, thus dimensions, particle sizes, and other aspects may, and generally are, exaggerated to make illustrations thereof clearer. Therefore, departure can be made from the specific dimensions and aspects shown in the figures in order to produce the cutting devices of the present invention.

### SUMMARY

A method of forming one or more features on a working surface of a superhard carbonaceous material, comprising:

positioning an electrode plate adjacent the superhard carbonaceous material, the electrode plate having an electrode surface oriented toward the working surface of the superhard carbonaceous material, the electrode surface including at least one protrusion or indentation formed therein or thereon;

moving the electrode plate and the working surface toward one another while removing material from the working surface via electro-discharge machining; and

moving the electrode plate and the working surface laterally relative to one another while removing material from the working surface via electro-discharge machining.

In accordance with another aspect of the invention, an elevational relationship between the electrode plate and the working surface is maintained substantially constant while moving the electrode plate and the working surface laterally relative to one another while removing material from the working surface via electro-discharge machining.

In accordance with another aspect of the invention, material is removed from the working surface via electro-discharge machining while the electrode plate and the working surface are moved laterally and elevationally relative to one another.

In accordance with another aspect of the invention, the electrode plate comprises an anode and the working surface of the superhard carbonaceous material comprises a cathode.

In accordance with another aspect of the invention, the electrode plate comprises a cathode and the working surface of the superhard carbonaceous material comprises an anode.

In accordance with another aspect of the invention, the electrode surface includes a plurality of protrusions extending therefrom.

In accordance with another aspect of the invention, the method further includes:

disengaging the electrode plate and the working surface from one another;

rotating the electrode plate and the working surface relative to one another; and

reengaging the electrode plate and the working surface and further removing material from the working surface via electro-discharge machining.

In accordance with another aspect of the invention, a method of forming or altering one or more features on a working surface of a superhard carbonaceous material provided, including:

positioning an electrode plate adjacent the superhard carbonaceous material, the electrode plate having an electrode surface oriented toward the working surface of the superhard carbonaceous material, the electrode surface including at least one protrusion extending therefrom, the at least one protrusion including at least one edge formed thereon;

moving the electrode plate and the working surface toward one another while removing material from the working surface with the at least one edge of the protrusion via electro-discharge machining; and

forming one or more features on the working surface by moving the electrode plate and the working surface laterally relative to one another while removing material from the working surface with the edge of the protrusion via electro-discharge machining.

In accordance with another aspect of the invention, the method further comprises alternating a height of the one or more features by laterally moving the edge of the protrusion relative to the one or more features and removing material from the one or more features via electro-discharge machining.

In accordance with another aspect of the invention, the method further comprises alternating a width of the one or more features by laterally moving the edge of the protrusion relative to the one or more features and removing material from the one or more features via electro-discharge machining.

In accordance with another aspect of the invention, the method further comprises alternating a spacing distance between two or more features by laterally moving the edge of the protrusion relative to the one or more features and removing material from the one or more features via electro-discharge machining.

In accordance with another aspect of the invention, the edge extends from the electrode plate at an oblique angle relative to the working surface of the superhard carbonaceous material.

In accordance with another aspect of the invention, a volume of superhard carbonaceous material removed during the electro-discharge machining process can be greater than volume of the superhard carbonaceous material that is consumed by a combined volume of the protrusions extending from the electrode plate.

In accordance with another aspect of the invention, a volume of material removed from the superhard carbonaceous material during lateral movement of the material and the electrode plate is greater than a lateral surface area of the protrusions.

In accordance with another aspect of the invention, an electro-discharge machining system for forming one or more features on a working surface of a superhard carbonaceous material is provided, comprising:

an electrode plate carrier;

an electrode plate carried by the electrode plate carrier, the plate having an electrode surface, the electrode surface including at least one protrusion or indentation formed therein or thereon;

a workpiece carrier;

a superhard carbonaceous material, carried by the workpiece carrier and including a working surface defined thereon;

a movement generating system, capable of moving the workpiece carrier and the electrode plate carrier relative to one another in at least three directions of translational motion while the electrode plate removes material from the superhard carbonaceous material via electro-discharge machining.

There has thus been outlined, rather broadly, various features of the invention so that the detailed description thereof that follows may be better understood, and so that the present contribution to the art may be better appreciated. Other features of the present invention will become clearer from the following detailed description of the invention, taken with any accompanying or following claims, or may be learned by the practice of the invention.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification, the singular forms “a,” “an” and “the” include plural referents unless the context clearly dictates otherwise. Thus, for example, reference to “a cutting element” includes one or more of such elements and reference to “a brittle material” includes reference to one or more of such a material.

Definitions

In describing the present invention, the following terminology will be used in accordance with the definitions set forth below.

As is known in the art, “mesh” refers to the number of holes per unit area as in the case of U.S. meshes. All mesh sizes referred to herein are U.S. mesh unless otherwise indicated. Further, mesh sizes are generally understood to indicate an average mesh size of a given collection of particles since each particle within a particular “mesh size” may actually vary over a small distribution of sizes.

As used herein, the term “substantially” refers to the complete or nearly complete extent or degree of an action, characteristic, property, state, structure, item, or result. For example, when two or more objects are referred to as being spaced a “substantially” constant distance from one another, it is understood that the two or more objects are spaced a completely unchanging distance from one another, or so nearly an unchanging distance from one another that a typical person would be unable to appreciate the difference. The exact allowable degree of deviation from absolute completeness may in some cases depend upon the specific context. However, generally speaking the nearness of completion will be so as to have the same overall result as if absolute and total completion were obtained.

The use of “substantially” is equally applicable when used in a negative connotation to refer to the complete or near complete lack of an action, characteristic, property, state, structure, item, or result. As an arbitrary example, a cavity that is “substantially free of” foreign matter would either completely lack any foreign matter, or so nearly completely lack foreign matter that the effect would be the same as if it completely lacked foreign matter. In other words, a cavity that is “substantially free of” foreign matter may still actually contain minute portions of foreign matter so long as there is no measurable effect upon the cavity as a result thereof.

As used herein, “working surface” refers to a portion of a tool which contacts or is configured to contact material of a workpiece during a planing or dressing procedure. In some aspects, the working surface may merely be oriented toward a workpiece to be machined, but may not actually contact the workpiece.

As used herein, the term cutting “edge” can be used to refer to a portion of a cutting element that includes some measurable width across a portion that contacts and removes material from a workpiece. As an exemplary illustration, a typical knife blade has a cutting edge that extends longitudinally along the knife blade, and the knife blade would have to be oriented transversely to a workpiece to scrape or plane material from the workpiece in order for the cutting “edge” of the knife blade to remove material from the workpiece.

As used herein, “superhard” may be used to refer to any crystalline, or polycrystalline material, or mixture of such materials which has a Mohr's hardness of about 8 or greater. In some aspects, the Mohr's hardness may be about 9.5 or greater. Such materials include but are not limited to diamond, polycrystalline diamond (PCD), cubic boron nitride (cBN), polycrystalline cubic boron nitride (PcBN) as well as other superhard materials known to those skilled in the art. Superhard materials may be incorporated into the present invention in a variety of forms including particles, grits, films, layers, compacts, etc.

As used herein, various components of electro-discharge machining systems are sometimes discussed as moving vertically, horizontally, laterally, elevationally, etc., relative to one another. It is to be understood that such terms are used in an effort to clearly describe the features of the present invention and are not intended to limit the invention. For example, it is anticipated that some systems in accordance with the present invention will include an electrode plate and a carbonaceous material that move vertically relative to one another prior to making contact with one another (or nearly making contact, as the particular electro-discharge machining system may dictate), similar to commonly known drill presses. However, it is anticipated that horizontally oriented electro-discharge machining systems can also be provided, with a range of varying other orientations being contemplate: it is intended that such systems fall within the scope of the present invention.

As used herein, the term “electrode plate” is to be understood to refer to an electrode device that includes both a length dimension and a width dimension in some substantive degree. Examples of electrode plates include devices similar to those commonly used in “stamp” EDM processes, “sinker” EDM processes, “ram” EDM processes, etc. The term “electrode plate” specifically excludes structures akin to wires used in conventional wire EDM processes, as these structures do not include a substantial width (or height) dimension.

As used herein, the term “peak” can be used to refer to a relative portion of a cutting element that extends the greatest distance from a base of a cutting element. Thus, when oriented to contact a workpiece, the peaks of cutting elements of a cutting device would contact the surface of the workpiece prior to any other portion of the cutting device contacting the workpiece.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, particle sizes, volumes, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 micrometer to about 5 micrometers” should be interpreted to include not only the explicitly recited values of about 1 micrometer to about 5 micrometers, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

The Invention

In accordance with one embodiment, the present invention provides a method of forming one or more features on a working surface of a superhard carbonaceous material. The features formed can include, without limitation, cutting elements, cutting edges, blades, protrusions, teeth, etc. In one exemplary embodiment, the present invention is utilized to form various cutting elements on the face of a polycrystalline diamond (“PCD”) compact to produce a cutting device from the PCD compact. Cutting devices formed in accordance with the present invention can be utilized in cutting or otherwise affecting a workpiece to remove material from the workpiece to, among other applications, provide a finished, smooth and/or flat surface to the workpiece. Cutting devices of the present invention can be advantageously utilized, for example, as planing devices that plane material from a workpiece, as dressing devices that dress or condition various workpieces, and as polishing devices that polish various workpieces.

With reference to the accompanying figures, in accordance with one embodiment of the invention, a method of forming one or more features on a working surface of a superhard carbonaceous material can include positioning an electrode plate 12 adjacent a superhard carbonaceous material 14. The electrode plate can have an electrode surface 16 that is generally oriented toward a working surface 18 of the superhard carbonaceous material. The electrode surface can include at least one protrusion 20 or indentation 22 formed therein or thereon.

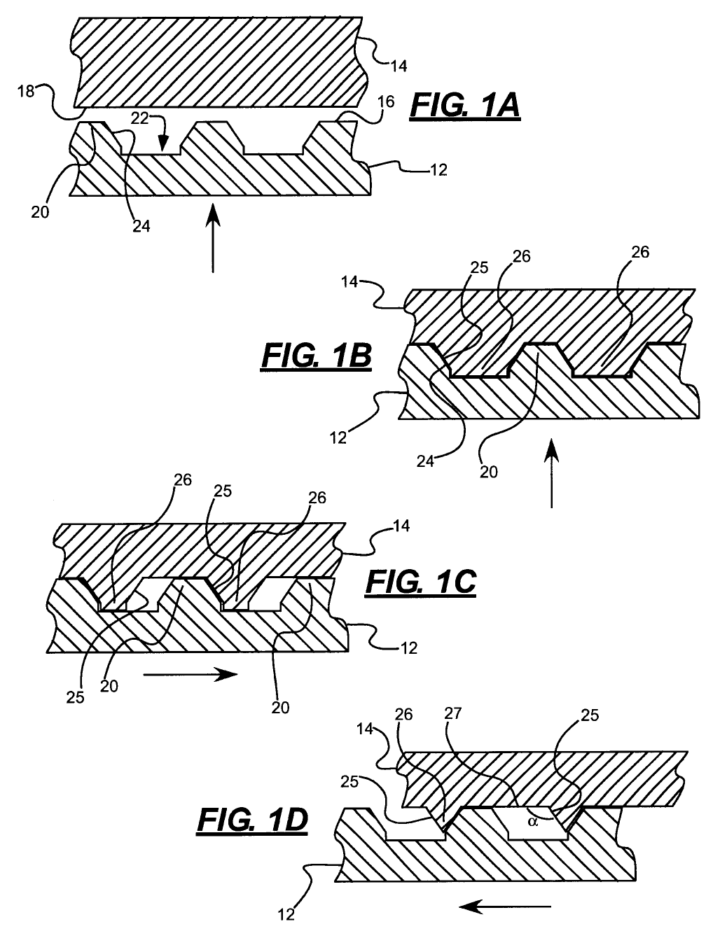

In an initial procedure (shown by example in FIGS. 1A and 1B), the method can include moving the electrode plate and the working surface toward one another while removing material from the working surface via electro-discharge machining. After this, the method can include moving the electrode plate and the working surface laterally relative to one another while removing material from the working surface via electro-discharge machining (two directions of lateral travel are shown in FIGS. 1C and 1D).

One or more of the protrusions 20 formed on the electrode plate can include an edge or face 24 that can protrude or extend from the electrode plate at an angle relative to the working surface of the superhard carbonaceous material. It will be appreciated that, as face 24 removes material from the carbonaceous material, a corresponding face 25 (FIGS. 1B, 1C and 1D) can be formed in the carbonaceous material. For purposes of the present discussion, the angle “α” (FIG. 1D) formed by the face 25 relative to an immediately adjacent surface 27 will be discussed herein as “positive” if the angle α is greater than 90 degrees and “negative” if the angle α is less than 90 degrees, and “neutral” if the angle α is about 90 degrees.

Thus, the angles of the faces 24 (and the resultingly formed faces 25) in FIGS. 1A through 1D are all positive angles. However, it is to be understood that the angles can all be roughly neutral angles as well (e.g., each would appear as substantially vertical in the exemplary figures).

Also, as shown in FIG. 3A, in one aspect of the invention, one or more angles formed by the protrusions 20a of the superhard carbonaceous material 12a can be negative. This aspect of the invention can be advantageous in forming cutting teeth, blades or edges in a superhard carbonaceous material that form a negative angle with respect to the workpiece (not shown) that the superhard material is being used to condition, polish, plane, etc. Such a negative tooth, blade or cutting edge angle can aid in very cleanly cutting or otherwise removing material from the workpiece.

As shown in FIG. 3B, the protrusions 20b can include faces that are curved or arcuate, to form correspondingly (and inversely) curved or arcuate shapes on the cutting teeth of the superhard carbonaceous material. The curved or arcuate cutting faces can include a variety of angles as well.

While the exemplary embodiments illustrated in the figures include protrusions 20 that are substantially similarly sized and shaped, in some aspects of the invention adjacent protrusions can include differently shaped protrusions, or protrusions having differently angled faces. In this manner, adjacent cutting teeth on the resulting superhard carbonaceous material can be formed with varying degrees of cutting aggressiveness.

The combination of movement in a vertical or elevational direction (relative only to the orientation illustrated by example in the figures), and one or more lateral directions allows the removal of material from the superhard carbonaceous material in a wide variety of patterns. This feature of the invention can be advantageous in applications in which relatively complex landscapes are desired to be formed on the working surface of the superhard carbonaceous material. Such complex landscapes can be formed much more quickly, using the present invention, than with the very few conventional methods that can be utilized to machine superhard carbonaceous materials (for example, utilization of a wire EDM process would be much more time consuming and expensive).

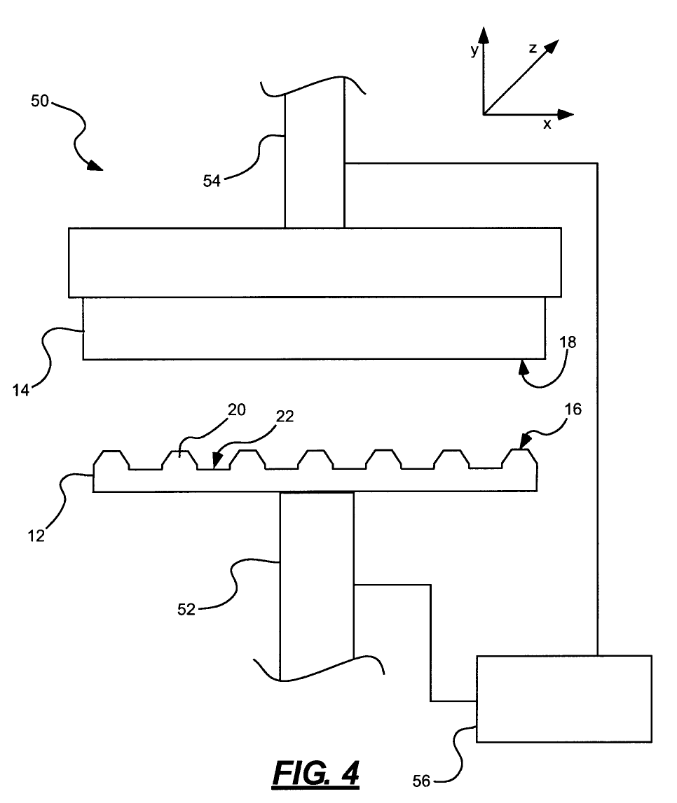

The present invention can be utilized to remove material from the superhard carbonaceous material while moving the carbonaceous material and the electrode plate relative to one another in one or more degrees of movement (e.g., in one or more of the X, Y and Z axes illustrated schematically in FIG. 4). In a basic process, material can be removed from the superhard carbonaceous material while moving the electrode and the carbonaceous material laterally relative to one another while maintaining a substantially constant elevational relationship between the electrode plate and the working surface. In other applications, movement in substantially simultaneous lateral and elevational directions can be affected while the electro-discharge machining process is underway.

It some embodiments, material can be removed from the superhard carbonaceous material via electro-discharge machining while the superhard material and the electrode plate are positioned in first orientation, after which they can be repositioned and electro-discharge machining resumed. This can result firstly in substantially parallel grooves being formed in the superhard carbonaceous material (which results in elongate cutting edges being formed on the elongate protrusions). After this, the superhard material and the electrode can be rotated relative to one another and further material can be removed from the carbonaceous material to form individual teeth or protrusions on the superhard material, as shown for example in the cutting devices photographed in FIGS. 5-6.

In the examples shown in FIGS. 5-6, the cutting elements, teeth or protrusions can be formed in pyramidal shapes. The present inventor has found that such a configuration provides a number of advantages. For example, pyramidal-shaped cutting elements concentrate most of the volume/mass of the cutting element toward a lowermost portion of the cutting element, ensuring that the cutting element is more securely held to whichever type of base (e.g., cutting tool) the elements are bonded to, integrated with, or otherwise associated with. In addition, by forming pyramids with a triangular base, the support base of the pyramids is even more massive relative to the tip, and the tip can be made sharper (e.g., 60 degrees) without breaking or fracturing during the dressing of CMP pads.

While the protrusions 20 shown in the figures include generally planar side and/or top surfaces, they can include curved or arched features as well. Also, even in the case where cutting edges of the protrusions are sharply angled, relative movement of the electrode plate and the superhard carbonaceous material can be accomplished in such a way that curved or arcuate features are formed in the superhard carbonaceous material.

In one embodiment of the invention, the superhard carbonaceous material (for example, a PCD or PcBN compact) can serve as the anode of the EDM process, with the electrode plate serving as the cathode. However, this relationship can also be reversed, with the electrode plate being used as the anode and the PCD being used as the cathode. In this aspect, PCD material removal rate can be relatively rapid (generally speaking, both the anode material and the cathode material will be consumed, at varying rates, during the EDM process). However, by reversing the polarity (e.g., by using the PCD as the anode), the PCD material removal rate may be slower but the surface finish of the PCD may be more evenly formed.

As illustrated in FIGS. 1A through 1D, the present invention can allow for adjustment of various features of the cutting teeth or protrusions 26 formed in the superhard carbonaceous material. For example, a spacing between adjacent cutting elements can be adjusted according to a magnitude or lateral movement between the carbonaceous material and the electrode plate. In addition, a height of the cutting teeth 26 can be adjusted when the angle α of the faces 25, 26 are either positive or negative. Of course, a width of the cutting teeth can also be adjusted by altering a magnitude of lateral movement between the carbonaceous material and the electrode plate.

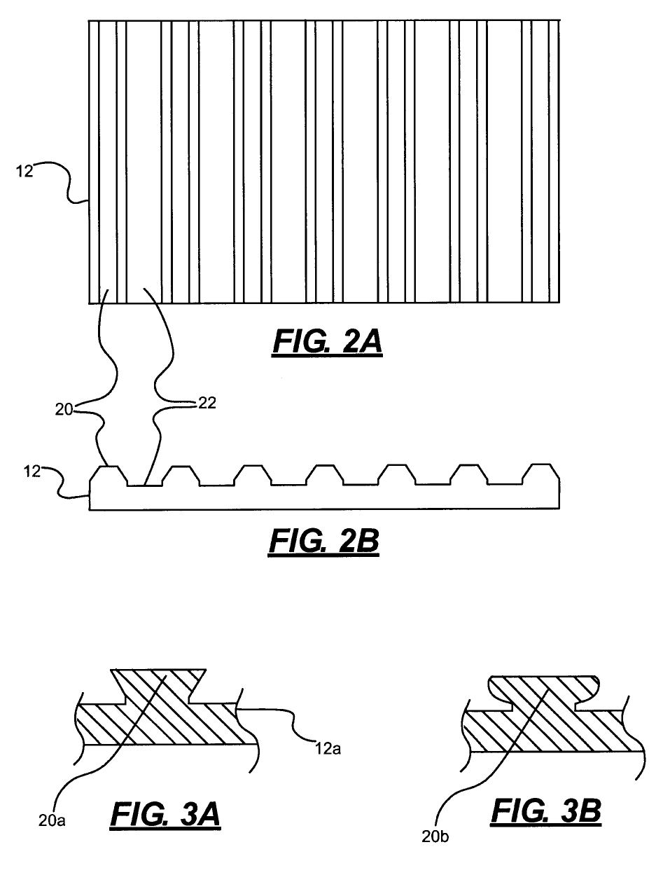

As illustrated schematically in FIG. 4, in one aspect of the invention, an electro-discharge machining system 50 is provided that can be utilized to form one or more features on a working surface of a superhard carbonaceous material 14. The system can include an electrode plate carrier 52 and an electrode plate 12 carried by the electrode plate carrier. The electrode plate can be similar to the embodiments discussed relative to FIGS. 1A-3, and can include an electrode surface 16 having at least one protrusion 20 and/or indentation 22 formed therein or thereon.

A workpiece carrier 54 can carry a superhard carbonaceous material 14, with the superhard carbonaceous material including a working surface 18 defined thereon. A movement generating system (shown schematically at 56) can be capable of moving the workpiece carrier and the electrode plate carrier relative to one another in at least three directions of translational motion (e.g., in any or all of X, Y and Z axes illustrated) while the electrode plate removes material from the superhard carbonaceous material via electro-discharge machining. Rotational movement of the electroplate carrier and the workpiece carrier can also be effectuated.

It is anticipated that a variety of electro-discharge machining systems known to those of ordinary skill in the art of such endeavors can be adapted for use with the present system. The movement generating system 56, while not being a part of such conventional electro-discharge machining systems, can also be readily understood by one ordinary skill in the art of various machining techniques used outside of the electro-discharge machining field, including movement systems commonly utilized in Computer Aided Machining (“CAM”) systems.

It will be appreciated that electro-discharge machining systems generally require an electrically conductive (or at least semi-conductive) anode and cathode. The superhard carbonaceous material of the present invention can be made conductive in a variety of manners. In one aspect, the superhard material includes a PCD or PcBN compact material that can be machined via electro-discharge machining without significantly comprising the compact's hardness, wear resistance, thermal stability, cutting ability, etc. In one example, the compact material can include a significant percentage of diamond crystals that are conductive or semiconductive in nature, or which include conductive or semiconductive outer surface layers. Such diamond crystals can include small quantities of interstitial impurities such as lithium (Li), beryllium (Be), boron (B), and aluminum (Al) that are sufficient to provide the conductivity or semiconductivity.

In one embodiment, the superhard carbonaceous compact of the present invention can be formed by using semiconductive diamond grit feedstock formed of semiconductive diamond crystals doped with Li, Be or Al or combinations thereof. In other cases, the compact can be formed by using a combination of semiconductive and conventional, non-conductive diamond grit feedstock such as Type I diamond grit feedstock. In other cases, the compact can be formed using conventional undoped diamond grit feedstock (such as Type I diamond grit feedstock) together with a suitable quantity of additives such as B, Li, Be and Al. The additives can diffuse throughout the diamond lattice so as to cause the diamond crystals to transform to diamond crystals that include semiconductive surface layers. One such typical diffusion phenomenon takes place during the HTHP sintering process used to solidify PCD or PcBN materials.

The superhard carbonaceous material used can be in the form of PCD or PcBN compacts that are superhard, resulting in little yielding by the cutting elements when pressed against a wafer. As hardness is generally a measure of energy concentration, e.g., energy per unit volume, the PCD or PcBN compacts of the present invention are capable of concentrating energy to a very small volume without breaking. These materials can also be maintained with a very sharp cutting edge due to their ability to maintain an edge within a few atoms.

An electrolytically conducting slurry may be used to bridge the two electrodes utilized, as in known to those of ordinary skill in conventional stamp (or ram) EDM processes. As is also known, various additives can be introduced into the slurry to improve the electro-discharge machining process. Some such slurries can be particularly advantageous in the present invention in that a distance between the electrode plate surface 16 and the working surface of the compact 14 can be increased during the machining process, allowing a better flow of slurry away from the compact as material is removed from the compact. The ability of the present invention to increase the spacing between cutting teeth or protrusions 20 can further enhance this process, as larger spacing distances can create larger channels between teeth, allowing the through-put of a large amount of slurry.

It is to be understood that the above-described arrangements are only illustrative of the application of the principles of the present invention. Numerous modifications and alternative arrangements may be devised by those skilled in the art without departing from the spirit and scope of the present invention and the description herein is intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

We claim:

1. A method of forming one or more features on a working surface of a superhard carbonaceous material, comprising:
positioning an electrode plate adjacent the superhard carbonaceous material, the electrode plate having an electrode surface oriented toward the working surface of the superhard carbonaceous material, the electrode surface including at least one protrusion or indentation formed therein or thereon;
moving the electrode plate and the working surface toward one another while removing material from the working surface via electro-discharge machining; and
moving the electrode plate and the working surface laterally relative to one another while removing material from the working surface via electro-discharge machining.

2. The method of claim 1, wherein an elevational relationship between the electrode plate and the working surface is maintained substantially constant while moving the electrode plate and the working surface laterally relative to one another while removing material from the working surface via electro-discharge machining.

3. The method of claim 1, wherein material is removed from the working surface via electro-discharge machining while the electrode plate and the working surface are moved laterally and elevationally relative to one another.

4. The method of claim 1, wherein the electrode plate comprises an anode and the working surface of the superhard carbonaceous material comprises a cathode.

5. The method of claim 1, wherein the electrode plate comprises a cathode and the working surface of the superhard carbonaceous material comprises an anode.

6. The method of claim 1, wherein the electrode surface includes a plurality of protrusions extending therefrom.

7. The method of claim 1, further comprising:
disengaging the electrode plate and the working surface from one another;
rotating the electrode plate and the working surface relative to one another; and
reengaging the electrode plate and the working surface and further removing material from the working surface via electro-discharge machining.

8. A method of forming or altering one or more features on a working surface of a superhard carbonaceous material, comprising:
positioning an electrode plate adjacent the superhard carbonaceous material, the electrode plate having an electrode surface oriented toward the working surface of the superhard carbonaceous material, the electrode surface including at least one protrusion extending therefrom, the at least one protrusion including at least one edge formed thereon;
moving the electrode plate and the working surface toward one another while removing material from the working surface with the at least one edge of the protrusion via electro-discharge machining; and
forming one or more features on the working surface by moving the electrode plate and the working surface laterally relative to one another while removing material from the working surface with the edge of the protrusion via electro-discharge machining.

9. The method of claim 8, further comprising alternating a height of the one or more features by laterally moving the edge of the protrusion relative to the one or more features and removing material from the one or more features via electro-discharge machining.

10. The method of claim 8, further comprising alternating a width of the one or more features by laterally moving the edge of the protrusion relative to the one or more features and removing material from the one or more features via electro-discharge machining.

11. The method of claim 8, further comprising alternating a spacing distance between two or more features by laterally moving the edge of the protrusion relative to the one or more features and removing material from the one or more features via electro-discharge machining.

12. The method of claim 11, wherein the edge extends from the electrode plate at an oblique angle relative to the working surface of the superhard carbonaceous material.

13. The method of claim 8, wherein a volume of superhard carbonaceous material removed during the electro-discharge machining process is greater than a volume of the superhard carbonaceous material that is consumed by a combined volume of the protrusions extending from the electrode plate.

14. The method of claim 8, wherein a volume of material removed from the superhard carbonaceous material during lateral movement of the material and the electrode plate is greater than a lateral surface area of the protrusions.

15. An electro-discharge machining system for forming one or more features on a working surface of a superhard carbonaceous material, comprising:
an electrode plate carrier;
an electrode plate carried by the electrode plate carrier, the plate having an electrode surface, the electrode surface including at least one protrusion or indentation formed therein or thereon;
a workpiece carrier;
a superhard carbonaceous material, carried by the workpiece carrier and including a working surface defined thereon; and
a movement generating system, capable of moving the workpiece carrier and the electrode plate carrier relative to one another in at least three directions of translational motion while the electrode plate removes material from the superhard carbonaceous material via electro-discharge machining.
